(19) United States
(12) Patent Application Publication
(10) Pub. No.: US 2011/0099577 A1
(43) Pub. Date: Apr. 28, 2011

(54) FILTERING OF DYNAMIC SERVICES IN CACHED SERVICE ACQUISITION DATA

(76) Inventors: David Anthony Campana, Princeton, NJ (US); David Brian Anderson, Florence, NJ (US); Alan Jay Stein, Princeton Junction, NJ (US)

(21) Appl. No.: 12/737,225

(22) PCT Filed: Jun. 29, 2009
(86) PCT No.: PCT/US09/03853

§ 371 Date: Dec. 20, 2010

Related U.S. Application Data
(60) Provisional application No. 61/077,543, filed on Jul. 2, 2008.

(51) Int. Cl. G06F 13/00

(52) U.S. Cl. 725/39

(57) ABSTRACT

At a receiving device after a power-on or physical channel change, the physical channel is monitored for activity relating to services for which electronic service guide (ESG) data had been previously cached. The ESG data for a service will include some service identification information, such as an interne protocol (IP) address associated with the service. The monitoring of the physical channel for activity related to a service can be done by listening for the IP address associated with the service. If activity is detected, the service is determined to be active and its cached ESG data valid. Service acquisition data included in the cached ESG data is used to present the service to the user. The invention thus allows the presentation of services to the user using cached ESG data as soon as the services are detected to be active, without the need to wait for the reception of fresh ESG data. The cached ESG data of services for which no activity is detected is not used and may be deleted from the cache after a certain period.

### RELATED PATENT APPLICATIONS

This application claims the benefit under 35 U.S.C. §119(e) of U.S. Provisional Application No. 61/077,543, filed Jul. 2, 2008, the entire contents and file wrapper of which are hereby incorporated by reference for all purposes into this application.

### FIELD OF INVENTION

The present invention generally relates to communications systems and, more particularly, to digital broadcast systems and electronic service guide services.

### BACKGROUND

Digital television broadcast systems typically feature an electronic service guide (ESG) mechanism for transmitting data relating to service acquisition, service information, and schedule, among other things. Through information provided by the ESG mechanism, end-users can select services and items in which they may be interested and find stored items on their terminals. Examples of services for which ESG information may be provided, include, among others, audio, video and file download services, as well as the ESG itself. Examples of standardized ESG formats include those defined by DVB-CBMS, TV-Anytime and the Open Mobile Alliance (OMA).

In a digital broadcast system using Internet Protocol (IP)-based service encapsulation, data for a given service is represented as a set of one or more IP streams, where each stream is associated with some IP address (and/or port). An IP encapsulation scheme is specified, for example, for DVB-H and is also proposed for ATSC-M/H. IP streams for the variety of services available on a given physical channel are multiplexed and broadcasted in time bursts of data. When a receiving device presents to a user a service selected by the user (e.g., a video stream of a selected network TV channel), the receiving device will receive all of the data within the broadcasted time bursts of data (e.g., video streams for all available TV channels), but select, process and present only the data associated with the selected service. With IP-based systems, the association is typically made using the IP addresses associated with the services selected. Service acquisition data provided by the ESG mechanism will identify the IP addresses that are relevant for a given service, using, for example, Session Description Protocol (SDP) syntax. The ESG itself may be a service within the multiplex of data.

The ESG data for the set of services available on a given physical channel is typically transmitted on that same physical channel. Thus, in order to receive ESG data for a physical channel, a receiving device must first tune to that channel. It may take a receiving device several seconds after power-on or after tuning to a given channel to receive sufficient ESG data to identify the services offered on that channel and to present them to the user.

A receiving device can improve the user experience by caching the service acquisition data for a given physical channel so that this information is available after the channel has been changed or the power has been turned off and back on. Upon return to the channel or power-on, it is assumed that the last valid configuration is still valid until service acquisition data can be received to inform the receiver otherwise.

Relying on cached service acquisition data, however, can be problematic, particularly where the set of services offered on a given channel is dynamic. For example, in a broadcast system offering a variety of services, it may be desirable for the system operator to have the ability to dynamically control the set of services available at a given moment. For instance, mobile broadcast services may be consumed the most during the day, when users are out of their homes and on the go. Likewise, high definition (HD) television services may be consumed the most during prime time viewing hours when users are more likely to be at home with access to large screen HD terminals. Because of this, a system operator may chose to allocate more bandwidth to mobile services during daytime hours, and more bandwidth to HD services during evening hours—for example, offering a standard definition (SD) service along with two mobile services and no HD services during the day but offering an SD service and an HD service with no mobile services during the evening. To accommodate such changes in service, the set of services broadcast on a given physical channel may change during the day, in which case service acquisition data that was previously cached may not accurately reflect the set of services currently available. Until updated ESG data is received, the receiving device will not be able to present to the user services whose cached service acquisition data is no longer valid. Therefore, in cases where service availability has changed, caching ESG data at a receiving device can provide a diminished user experience as the user may not be presented with services until the receiving device once again receives valid service acquisition data.

Some ESG standards offer fields for identifying time windows when fragments of ESG data are valid. For example, the Open Mobile Alliance “Service Guide for Mobile Broadcast Services” specification offers validFrom and validTo fields for identifying the valid time window for a given service. (See, e.g., OMA-BCAST Service Guide for Mobile Broadcast Services, Draft Version 1.1, May 19, 2009). The applicability of these fields, however, is limited with respect to the above-discussed problem. These fields provide for absolute date/time identification of validity windows. This restricts the receiver's usage of these fields to only those time windows included in the cached ESG data. It is possible and quite likely that a receiver may be turned off and then back on at a later time outside of the applicable validity window.

Additionally, usage of these fields from the cached ESG data presents a problem for cases where a service broadcasts a live event that does not have a clearly defined end time before going offline. The validTo field could only represent a best guess of the end time of a live event (and thus service validity), thereby resulting in the aforementioned service presentation delay problem.

### SUMMARY

In an exemplary method of the invention, at a receiving device after a power-on or physical channel change, the physical channel is monitored for activity relating to services for which electronic service guide (ESG) data had been previously cached. The ESG data for a service will include some service identification information, such as an interne protocol (IP) address associated with the service. The monitoring of the physical channel for activity related to a service can be done by listening for the IP address associated with the service. If activity is detected, the service is determined to be active and its cached ESG data valid. Service acquisition data included in the cached ESG data is used to present the service to the user. The exemplary method thus allows the presentation of services to the user using cached ESG data as soon as the services are detected to be active, without the need to wait for the reception of fresh ESG data. The cached ESG data of services for which no activity is detected is not used and may be deleted from the cache after a certain period.

Exemplary embodiments in accordance with the invention allow for fast acquisition of available services on a physical channel upon power-on of the receiving device or a change in the physical channel. This facilitates the dynamic scheduling of services on a given physical channel.

In view of the above, and as will be apparent from the detailed description and drawings, other embodiments and features are also possible and fall within the principles of the invention.

### BRIEF DESCRIPTION OF THE FIGURES

Some embodiments of apparatus and/or methods in accordance with embodiments of the present invention are now described, by way of example only, and with reference to the accompanying figures in which:

FIG. 1 is a block diagram of an illustrative system in accordance with the principles of the invention; and

FIG. 2 is a flowchart of an exemplary method of updating the validity of cached electronic service guide (ESG) data in accordance with the principles of the invention.

### DESCRIPTION OF EMBODIMENTS

Other than the inventive concept, the elements shown in the figures are well known and will not be described in detail. For example, other than the inventive concept, familiarity with Discrete Multitone (DMT) transmission (also referred to as Orthogonal Frequency Division Multiplexing (OFDM) or Coded Orthogonal Frequency Division Multiplexing (COFDM)) is assumed and not described herein. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC), Chinese Digital Television System (GB) 20600-2006 and DVB-H is assumed. Likewise, other than the inventive concept, other transmission concepts such as eight-level vestigial sideband (8-VSB), Quadrature Amplitude Modulation (QAM), and receiver components such as a radio-frequency (RF) front-end (such as a low noise block, tuners, down converters, etc.), demodulators, correlators, leak integrators and squarers is assumed. Further, other than the inventive concept, familiarity with protocols such as Internet Protocol (IP), Internet Protocol Encapsulator (IPE), Real-time Transport Protocol (RTP), RTP Control Protocol (RTCP), User Datagram Protocol (UDP), Transmission Control Protocol (TCP), Session Description Protocol (SDP), File Delivery over Unidirectional Transport (FLUTE) protocol, and Asynchronous Layered Coding (ALC) protocol, is assumed and not described herein. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

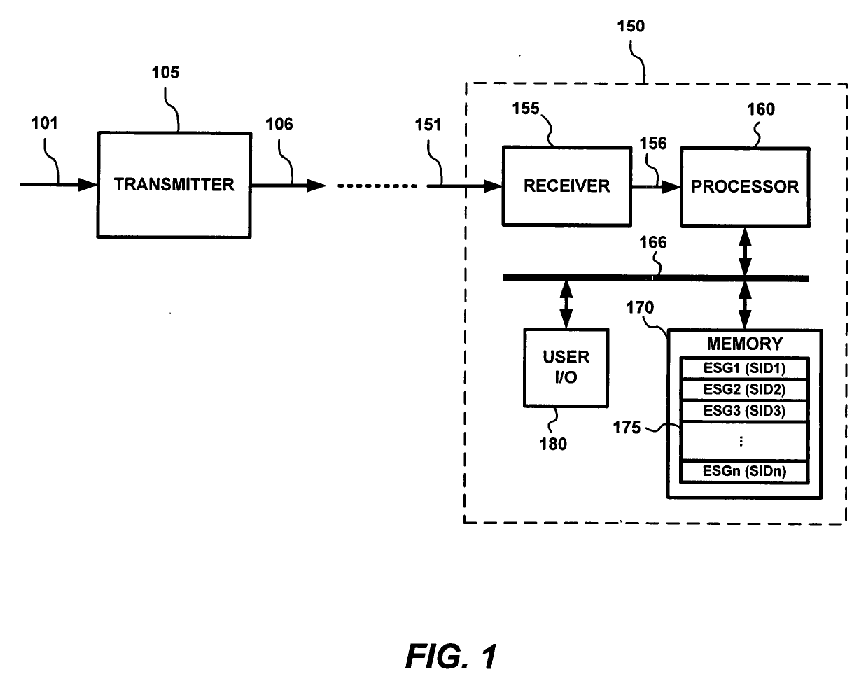

An illustrative system in accordance with the principles of the invention is shown in FIG. 1. Based on one or more input signals 101 a transmitter 105 transmits a signal 106 over a physical channel to one or more receiving devices, such as receiving apparatus 150. In an OFDM system, for example, signal 106 is broadcast over one or more frequency channels to which a receiving device can tune for reception of signal 106. The one or more input signals 101 can be from various sources of services to be provided via broadcast signal 106, such as, for example, a streaming audio/video service, file download service, or the like.

Receiving apparatus 150 comprises a receiver 155, such as a DTV receiver, a processor 160, data storage, such as a memory 170, and a user input/output interface block 180. As such, receiving apparatus 150 is a processor-based device. Receiving apparatus 150 may be, for example, a cell phone, mobile TV, set-top box (STB), or a digital TV (DTV) set, among others. In a device such as a cell phone which includes an integrated display and user input buttons, user I/O block 180 may represent the display and buttons. In a device such as a STB, however, user I/O block 180 may represent, for example, a High-Definition Multimedia Interface (HDMI) module, for interfacing to a HDTV monitor (not shown).

Receiver 155 receives signal 106 broadcast from transmitter 105 as represented by received signal 151. It is possible for the receiver 155 to receive multiple signals broadcast from multiple transmitters such as transmitter 105, in which case the received signal 151 will represent some combination of such signals. Based on user input typically, receiver 155 will tune to or select one of the broadcast signals contained in received signal 151 and generate signal 156 therefrom. Thus if receiver 155 is tuned to receive signal 106 broadcast from transmitter 105, signal 156 will be a representation of signal 106. The implementation and operation of transmitter 105 and receiver 155 can be conventional.

In a packet-based system, signals 106 and 156 convey packets of data, each packet being associated with one or more services provided over a physical channel to receiving apparatus 150. As discussed above, such services may include ESG, audio, video and file download services, among others.

As shown in FIG. 1, signal 156 is provided to processor 160 for processing, as described more fully below. Processor 160 is coupled via bidirectional bus 166 to user I/O block 180 and memory 170, to which it can write data and from which it can read data. Memory 170 can be random access memory (RAM) or the like. It is contemplated that memory 170 will retain its contents while receiving apparatus 150 is powered down or inactive.

Processor 160 establishes and maintains ESG cache 175 in memory 170 based on information extracted from ESG-related packets received by processor 160 via signal 156. Because different services are typically offered on different physical channels, ESG is typically channel-specific. As such, different ESG information will be transmitted on different channels. The processor 160, therefore, preferably caches ESG data for each physical channel to which the receiver 155 tunes. The cached ESG data can be organized into individual caches for each channel or a larger cache for multiple channels. For simplicity, one ESG cache 175 is shown and it is assumed to contain ESG data for one physical channel.

ESG cache 175 will contain ESG data for each of the services available on the associated physical channel. The cached ESG data will be associated with information identifying the service to which it pertains. Thus, as shown in FIG. 1, ESG cache 175 can be organized generally as a table of ESG data (ESG1-ESGn) with corresponding service identification information (SID1-SIDn). The service identification information may include, for example, IP addresses, port numbers, or MPEG packet identifiers (PIDs), among other possibilities. Preferably, the service identification information is information that is contained in packet headers or the like, which can be readily inspected without requiring decoding or extensive processing of encoded payload data. Furthermore, although it is contemplated that the associations between service and service identification information may change occasionally, it is preferable that such changes do not occur more frequently than the broadcasting of ESG data.

In an exemplary embodiment, the ESG data cached includes service acquisition data. Service acquisition data is the portion of ESG data that a given system broadcasts for use by receivers in acquiring services. It can be in whatever format the given system uses and may be standards-based or proprietary. As an example, for a system based on OMA-BCAST, the service acquisition data would contain the SDP fragments described in the OMA-BCAST Service Guide for Mobile Broadcast Services, Draft Version 1.1, May 19, 2009. (See also RFC 4566, Session Description Protocol.) The OMA-BCAST Service Guide describes several mechanisms for providing the parameters necessary to acquire a service. The IP address associated with a service can be obtained, for example, from the SDP element of the Access fragment described in the OMA-BCAST Service Guide (see, e.g., section 5.1.2.4). In such an embodiment, the receiver would cache the XML containing the Access fragments, which in turn contain the SDP.

As ESG data is received by processor 160 via signal 156, it is cached in cache 175. Upon power-on of receiving apparatus 150 or upon re-tuning of receiver 155 to the physical channel for which the cached ESG data pertains, processor 160 will update the validity of the cached ESG data, in accordance with an exemplary method described below. To the extent that the cached ESG data is still valid, it can be used to present services (via user I/O 180) to the user of receiving apparatus 150. Cached ESG data that is determined to be invalid is not used and may be deleted from the cache.

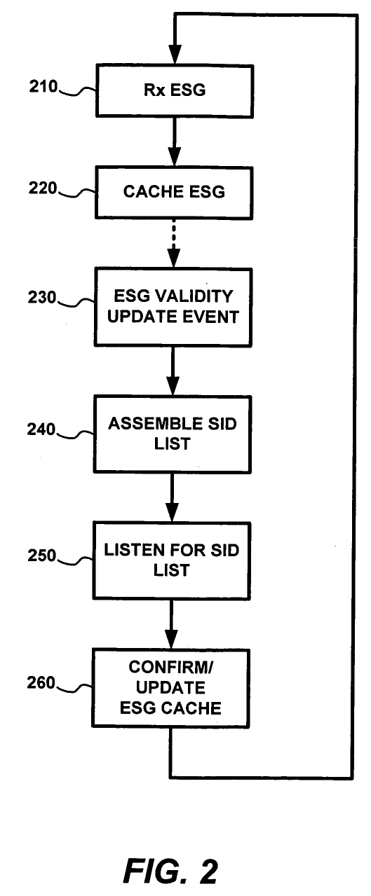

FIG. 2 is a flowchart of an exemplary method in accordance with the invention for handling cached ESG data. As mentioned above, receiving apparatus 150 will occasionally receive ESG data, as represented by step 210. The reception of ESG data can occur periodically at a regular interval, or randomly. At 220, the received ESG data is cached in memory 170. At some later time at 230, an event such as a power-on of receiving apparatus 150 or re-tuning of receiver 155 to a new physical channel will occur after which previously cached ESG data may no longer be valid, thereby warranting an update of the validity of the cached ESG data. It is contemplated that the occurrence of other events may also trigger such an update, such as the expiration of a time period since ESG data was last cached, among others.

At 240, a list of service identification information (SID) is assembled based on the cached ESG data. As mentioned above, the ESG data cached for each service will contain service acquisition data and information identifying the service, such as one or more IP addresses associated with the service. Other such identifying information may include, for example, UDP port numbers, and MPEG packet identifiers (PIDs). Additionally, the cached ESG data may contain validFrom and validTo fields for identifying time windows of validity for the cached ESG data (e.g., service acquisition data). Using such data and the service identification information, a list of identification information is assembled for those services which should be currently active according to the ESG data cached for them.

At 250, processor 160 of receiving apparatus 150 will listen to the incoming multiplex of data in signal 156 for any data associated with the services identified in the aforementioned list of service identification information. In other words, processor 160 will inspect the headers of packets received on the incoming multiplex of data to determine whether they contain identification information (e.g., IP addresses, port numbers, MPEG PIDs) found in the list. If listed identification information is detected in the incoming stream, the services corresponding to such identification information are determined to be active, confirming the validity of the ESG data previously cached for those services in cache 175. The ESG cache entries for those services can be marked as “confirmed” or the like at 260, thereby informing processor 160 or any other entity with access to the ESG cache 175 that those ESG cache entries can be relied upon to be valid. Thus, for identification information detected in the incoming data stream corresponding to services which cached ESG data indicates should be active, the cached ESG data is deemed to be valid and can be used to present said services to the user. As such, as soon as a service is detected to be active, the service acquisition data previously cached for the service can be used to acquire the service for presentation to the user, thereby avoiding the delays associated with waiting to receive updated ESG data after a power-up or physical channel change. As more data bursts are received, additional services may be detected as active, thus making them available for presentation to the user as well.

For service identification information in the aforementioned list that is not detected in the incoming stream, the corresponding cached ESG data will not be used to present services to the user. Such cached ESG data can be marked as “unconfirmed” or the like, at 260 thereby informing processor 160 or any other entity with access to the ESG cache 175 that those ESG cache entries cannot be relied upon to be valid. Cached ESG data whose validity has not been confirmed can be left in the cache until it is overwritten with new ESG data. Alternatively, if after the expiration of a predetermined interval no activity has been detected in association with service identification information in the list, a determination can be made that the cached ESG data associated with that identification information is invalid and the cached ESG data can be marked accordingly or deleted from the cache at 260. The interval for determining invalidity of cached ESG data can be, for example, a predetermined time interval or number of data bursts received.

The cached ESG data, as updated above, is used until ESG data is received again at 210, at which point ESG cache 175 is updated with the newly received ESG data.

It should be noted that a receiving device will typically receive all data within a time burst at the physical layer. Thus, there is no additional reception overhead for the receiving device to analyze all data received on a given physical channel.

As mentioned above, service identification information in received data bursts can be monitored by inspecting the headers of packets in the data bursts. In an exemplary embodiment, such monitoring is carried out by opening a socket for each IP address (and port) in the aforementioned ESG cache list. When data is received on that socket, the associated service is detected to be active and the ESG data cached for that service is confirmed to be valid. A driver stack is responsible for actually analyzing the packet headers and directing packets to the appropriate socket. The sockets could be left open for the duration that the receiver is powered on, with services marked active as data is received for them.

As is known, for power savings, time slicing mechanisms exist that allow a receiver to limit its reception to only those bursts of data relevant to a currently selected service. Time slicing saves power by shutting off reception for bursts that are not relevant for the service currently being consumed. For purposes of the exemplary methods described, where it is desired to quickly acquire a valid service at times when no service is being consumed yet (e.g., after power up or physical channel change), time slicing is irrelevant and can be disabled.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, some or all of the elements may be implemented in a stored-program-controlled processor, e.g., a digital signal processor or a general purpose processor, which executes associated software, e.g., corresponding to one, or more, steps, which software may be embodied in any of a variety of suitable storage media. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention.

1. An electronic service guide (ESG) method comprising:
receiving ESG data for a plurality of services available on a physical channel, the ESG data including service acquisition data for each of the plurality of services;
storing the ESG data;
monitoring the physical channel for activity relating to at least one of the plurality of services, wherein a service is determined to be an active service if activity relating to the service is detected on the physical channel; and
using the stored service acquisition data for an active service to present the active service to a user.

2. The method of claim 1, wherein the ESG data includes service identification data and monitoring the physical channel for activity includes listening on the physical channel for the service identification data of at least one of the plurality of services.

3. The method of claim 2, wherein the service identification data includes at least one of an internet protocol (IP) address, a port number, and a packet identifier (PID).

4. The method of claim 2, wherein listening on the physical channel for service identification data includes analyzing packet headers.

5. The method of claim 1, wherein the ESG data for at least one service includes data indicating a time window of validity of the ESG data, and wherein activity for the at least one service is monitored if within the time window of validity.

6. The method of claim 1, wherein the step of monitoring the physical channel for activity is performed after at least one of a power-on or channel change event.

7. The method of claim 1 comprising deleting ESG data stored for a service for which no activity is detected in a predetermined interval.

8. An electronic service guide (ESG) apparatus comprising:
a receiver, the receiver receiving data on a physical channel for a plurality of services available on the physical channel, the data including ESG data, the ESG data including service acquisition data for each of the plurality of services;
data storage, the data storage storing the ESG data;
a processor, the processor monitoring the data received on the physical channel for activity relating to at least one of the plurality of services, wherein the processor determines a service to be an active service if the processor detects activity relating to the service on the physical channel; and
a user interface, wherein the processor uses the stored service acquisition data for an active service to present the active service to a user via the user interface.

9. The apparatus of claim 8, wherein the ESG data includes service identification data and the processor monitors the data received on the physical channel by listening on the physical channel for the service identification data of at least one of the plurality of services.

10. The apparatus of claim 9, wherein the service identification data includes at least one of an interne protocol (IP) address, a port number, and a packet identifier (PID).

11. The apparatus of claim 9, wherein the processor listens on the physical channel for service identification data by analyzing packet headers.

12. The apparatus of claim 8, wherein the ESG data for at least one service includes data indicating a time window of validity of the ESG data, and wherein the processor monitors the data received on the physical channel for activity relating to the at least one service if within the time window of validity.

13. The apparatus of claim 8, wherein the processor monitors the data received on the physical channel for activity after at least one of a power-on or channel change event.

14. The apparatus of claim 8, wherein the processor deletes ESG data from the data storage for a service for which no activity is detected in a predetermined interval.
